(19) United States
(12) Patent Application Publication
(10) Pub. No.: US 2021/0301582 A1
(43) Pub. Date: Sep. 30, 2021

(54) Drive System

(71) Applicant: Sommer Antriebs- und Funktechnik GmbH, Kirchheim/Teck (DE)

(72) Inventor: Dieter Walddörfer, Lenningen (DE)

(21) Appl. No.: 17/183,378

(22) Filed: Feb. 24, 2021

(30) Foreign Application Priority Data
Mar. 27, 2020 (DE) 202020101653.9
Apr. 24, 2020 (DE) 202020102303.9

(51) Int. Cl. E05F 15/77; E05F 15/668; G07C 9/10; G07C 9/00; G05B 19/042

(52) U.S. Cl. CPC E05F 15/77; G05B 2219/2628; G07C 9/10; G07C 9/00896; G05B 19/0426; E05Y 2201/41; E05Y 2201/422; E05Y 2201/434; E05Y 2400/356; E05Y 2400/40; E05Y 2400/66; E05Y 2400/85; E05Y 2800/102; E05Y 2800/75; E05Y 2900/106; G07C 2009/00928; E05F 15/668

(57) ABSTRACT

A drive system for a garage door with an electric drive controlled by a control unit, by means of which drive the garage door is displaceable between a closed position and an open position. Furthermore, an operating unit is provided, into which input commands for controlling the garage door can be entered. An input command designed as a delivery input command is provided. When a delivery input command is entered, the operating unit causes a partial opening of the garage door for a preset time. After expiry of this time, the operating unit causes the garage door to automatically move to the closed position.

### CROSS REFERENCE TO RELATED APPLICATIONS

This application claims the priority of DE 202020101653.9 filed on 2020 Mar. 27 and the priority of DE 202020102303.9 filed on 2020 Apr. 24; all applications are incorporated by reference herein in their entirety.

### BACKGROUND

The invention relates to a drive system for a garage door.

Such a drive system generally comprises an electric drive, by means of which the garage door can be displaced between an open position and a closed position. The electric drive is controlled by a control unit that is arranged with the electric drive in the garage, the door opening of which can be closed by the garage door.

Such garages are directly, spatially connected to buildings, especially residences. Therefore, garages are not only used for storage of motor vehicles but also for storage of other items, especially those delivered by delivery persons.

The delivery of items, especially parcels, has increased very significantly in the recent past due to the increased use of online services. The items ordered online are delivered by delivery services to the orderer, at their home address. A problem arises when the orderer is not at home at the time of delivery. In this case, the delivery person must then inquire whether a neighbor of the orderer will accept the delivery, which is only possible to a certain extent, however.

Leaving the items being delivered in front of the front door is disadvantageous, since it is then easy for them to be stolen.

Therefore, efforts have been made to use garages for temporary storage of items being delivered.

Such a system is known, for example, from the control unit 20 2019 106 510 U1. The garage door drive system described there comprises at least one garage door drive device for driving a garage door of a garage, and at least one portable data processing device, wherein the garage door drive device is configured to be controlled by the portable data processing device. The garage door drive system is configured to displace the garage door to a partially open position that is variable based on the size of the item, in response to an input entered on the data processing device or information received regarding an item to be delivered into the garage.

EP 3 564 878 A1 relates to a method for delivering a delivery to a destination, wherein the delivery is assigned a unique shipment identifier, which is applied to the delivery and is stored in a first computer system for managing a plurality of deliveries. At the destination, there is a garage that can be closed by means of an automatic garage door, which can be controlled by a second computer system, wherein the shipment identifier on the delivery is read after reaching the destination and transmitted to the first computer system. The first computer system then transmits a message comprising the shipment identifier to the second computer system, in response to which the second computer system initiates the opening of the garage door, after which the delivery is transported through the garage door and placed inside the garage, after which the garage door is closed again.

In these systems, therefore, the garage door of a garage can be opened for a delivery of an item in order to place the item being delivered inside. Since the garage is closed again afterwards, the delivered object is secured against unauthorized removal.

It is disadvantageous in this regard, that to realize such systems, internet-capable units have to be provided, wherein the drive system for the garage, in particular, must also have internet access, which is associated with undesirably high design effort. Moreover, internet connections to be provided are problematic with regard to data security.

### SUMMARY

The invention relates to a drive system for a garage door (2) with an electric drive controlled by a control unit (4), by means of which drive the garage door (2) is displaceable between a closed position and an open position. Furthermore, an operating unit (7) is provided, into which input commands for controlling the garage door (2) can be entered. An input command designed as a delivery input command is provided. When a delivery input command is entered, the operating unit causes a partial opening of the garage door (2) for a preset time. After expiry of this time, the operating unit (7) causes the garage door (2) to automatically move to the closed position.

### DETAILED DESCRIPTION

The invention seeks to solve the problem of providing a drive system of the type mentioned at the outset that offers high functionality and security, yet low design effort.

The features of claim 1 are provided in order to solve this problem. Advantageous embodiments and expedient further developments of the invention are described in the dependent claims.

The invention relates to a drive system for a garage door with an electric drive controlled by a control unit, by means of which the garage door can be displaced between a closed position and an open position. Moreover, an operating unit is provided into which input commands for controlling the garage door can be input. An input command designed as a delivery input command is provided. In the presence of a delivery input command, the control unit causes the garage door to open partially for a preset time. After expiry of this time, the control unit causes the garage door to automatically move to the closed position.

The basic function of the drive system according to the invention is that with it, a garage door can be displaced between an open position, in which the garage door fully exposes the door opening of a garage, and a closed position, in which the garage door fully closes the door opening, in order that a motor vehicle can be driven into or out of the garage in the known manner.

In accordance with the invention, the garage is also used as secure intermediate storage for items being delivered, especially parcels delivered by a courier service. The delivered items are protected against unauthorized access when the garage is closed by the garage door.

Using the garage for storing items being delivered is advantageous when the orderer of the respective item is not home and the delivery person cannot personally hand the item to the orderer.

In this case, the delivery person has an authorization or release message that allows the delivery person to input a delivery input command, as an input command, into the control unit of the drive system, which is arranged outside the garage, preferably permanently installed in place.

In the control unit, a partial opening of the garage door is initiated by this delivery input command, such that the delivery person can introduce the item to be delivered into the interior space of the garage through the restricted opening set by the command. It is essential here that the partial opening be caused by the control unit only for a limited time, which preferably lies in the second or minute range. After expiry of this time, the control unit causes the garage door to close again and in this manner, the delivered item is protected against unauthorized access. The garage door is therefore controlled by the control unit, which controls the garage door drive via suitable commands.

An essential advantage of the invention is that the delivery person delivering an item is granted the exclusive option of entering the delivery input command without third parties gaining knowledge thereof. It is essential in this regard that this be enabled without an internet connection needing to be provided for the drive system, especially the electric drive with the control units.

Rather, the control unit of the drive system forms an intelligent and local unit by means of which the partial opening of the garage door is effected. To this end, the control unit has means for activating the delivery input command, which are known to a delivery person delivering the item.

The means for activation are made available to the delivery person exclusively, along with the delivery permission. One logistically especially straightforward variant provides for communicating the means for activating the delivery input command to the delivery person along with the order for the item to be delivered.

Since with online orders, a message generally has to be used to place an order for a product, specifying the means for activating the delivery input command on this order can therefore be implemented without any extra effort in terms of communication technology.

According to a first advantageous variant, an operating element is provided as means for activating the delivery input command in the operating unit.

In particular, the operating element is formed by a separate key.

This results in an especially straightforward input to the operating unit, which results in a high degree of operating convenience.

According to a second advantageous variant, a code can be input into the operating unit as a means for activating the delivery input command.

In particular, the code input occurs by pressing a sequence of keys on the operating unit.

This variant offers increased access security, since the code is only known to the delivery person.

This variant can be expanded advantageously insofar as multiple codes can be input to trigger different delivery input commands.

On the one hand, the user of the drive system can change the code for activating the delivery input command as needed by programming the control unit, in order to achieve increased access security.

On the other hand, by assigning different codes, different partial opening positions of the garage door can be activated, such as, for example, the garage door being opened to different extents for the partial opening positions, in order to adjust to differing sizes of items being delivered. The time period for which the partial opening is active can also be varied.

In general, the operating unit forms a unit permanently installed in place.

A door opening of a garage can be closed with the garage door, wherein the control unit is arranged outside the garage.

The control unit is therefore freely accessible to any passersby.

It is expedient for a wireless connection to be provided for a data exchange between the operating unit and the control unit.

Therefore, communication can take place between the control unit and the operating unit without laborious laying of cables.

According to an advantageous embodiment, a light-barrier arrangement is provided as a safety means.

This safety means satisfies the safety standard requirements that are compulsory when the operating unit is arranged beyond the visual range of the garage door and a user cannot see the garage door when operating the operating unit.

The light barrier arrangement then has to be attached at an attachment height less than 30 cm above the ground delimiting the door opening. If the light barrier arrangement is triggered, any motion of the garage door is stopped immediately for safety reasons.

This safety means can be advantageously integrated into the process of the partial opening by closing the garage door immediately following a triggering and subsequent release of the light barrier arrangement during the partial opening period.

In this way, yet further augmented safety is achieved when performing the partial opening, since for example, in the case of unexpected penetration of the light barrier arrangement by a person, especially the delivery person himself, the garage door is stopped.

Security while performing the partial opening is further increased by providing a continuously activated video monitoring unit for the region of the garage door.

This allows the events occurring during an opening to be recorded for documentation purposes and potentially, as evidence.

According to an advantageous embodiment, the operating unit sends commands to a control unit, which controls the electric drive.

Therefore, through the commands of the operating unit, the control unit and therefore the garage door are controlled by the operating unit.

It is advantageous for the control unit to send back an acknowledgement command in response to a command of the operating unit.

Through the acknowledgment commands, it can be checked in the operating unit, whether a command it sent out was actually executed.

This can be advantageously exploited such that when, in response to a command sent by the operating unit to close the garage door, the operating unit does not receive any acknowledgement command from the control unit to the effect that the garage door was closed, then the operating unit will send the command to the control unit to close the garage door once again.

This allows error conditions to be easily detected when it comes to requesting the garage door for deliveries of items to be delivered.

For example, if a command to close the garage door is sent from the operating unit in order to end the partial opening of the garage door and this is not executed, because, for example, the item to be delivered is lying in the region of the door opening, the operating unit therefore sends a command to close to the garage door at a later time once again, in the event that no acknowledgment signal is received, such that the garage door can be closed.

### BRIEF DESCRIPTION OF THE DRAWINGS

The invention is explained below based on the drawings. They show:

FIG. 1 Schematic depiction of the drive system according to the invention for a garage door on a door opening of a garage.

FIG. 2 Top-down view of the garage when the garage door is partially open.

FIG. 3 Expansion of the arrangement from FIGS. 1 and 2 to include a light barrier arrangement.

FIG. 4 Exemplary embodiment of an operating unit for the drive system from FIGS. 1-3.

### DETAILED DESCRIPTION OF THE PREFERRED EMBODIMENTS

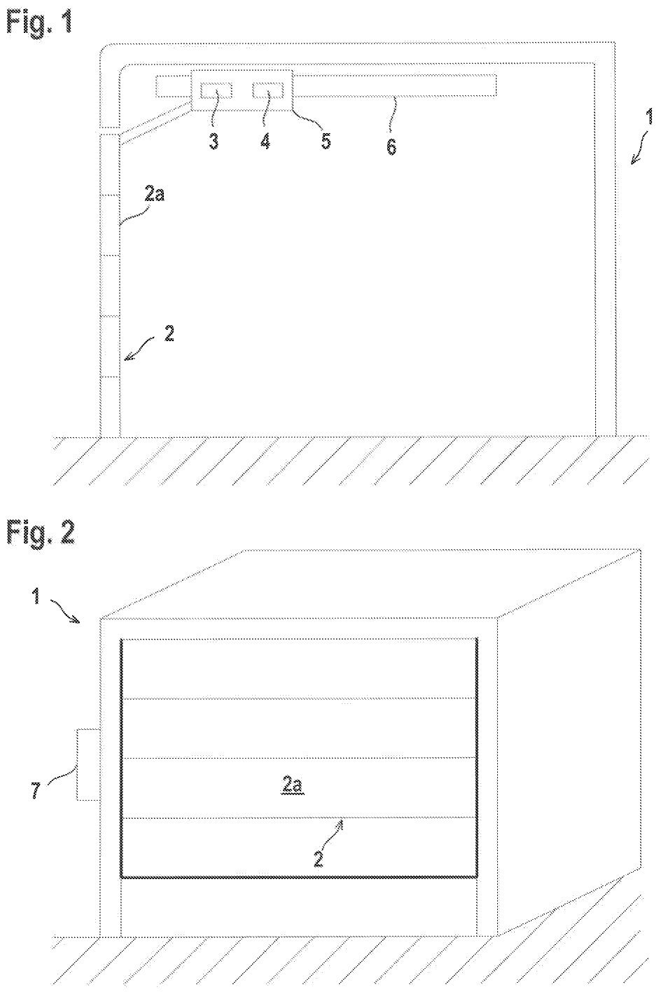

FIG. 1 shows a cross-sectional depiction of a garage 1, the door opening of which can be closed by means of a garage door 2. In the present case, the garage door 2 is formed as a sectioned door with an arrangement of sections 2a that are connected to one another in an articulated manner. FIG. 1 shows the garage door 2 in its closed position, in which the garage door 2 completely closes the door opening.

The drive system comprises an electric drive 3 and a control unit 4, which are arranged on a trolley 5 that is displaceable along a guide rail 6. For this purpose, the electric drive 3 can drive a drive wheel guided inside the guide rail 6.

The control unit 4 controls the electric drive, such that the trolley 5 can be moved along the guide rail 6, in order that the garage door 2 can be displaced between the closed position and an open position, in which the garage door 2 completely exposes the door opening.

FIG. 2 shows a top-down view of the garage 1 with the garage door 2 partially open.

On the outer side of the garage 1 or generally outside of the garage 1, an operating unit 7 is arranged, preferably stationary, as an additional component of the drive system. The operating unit 7 communicates with the control unit 4 by means of a wireless connection (not shown).

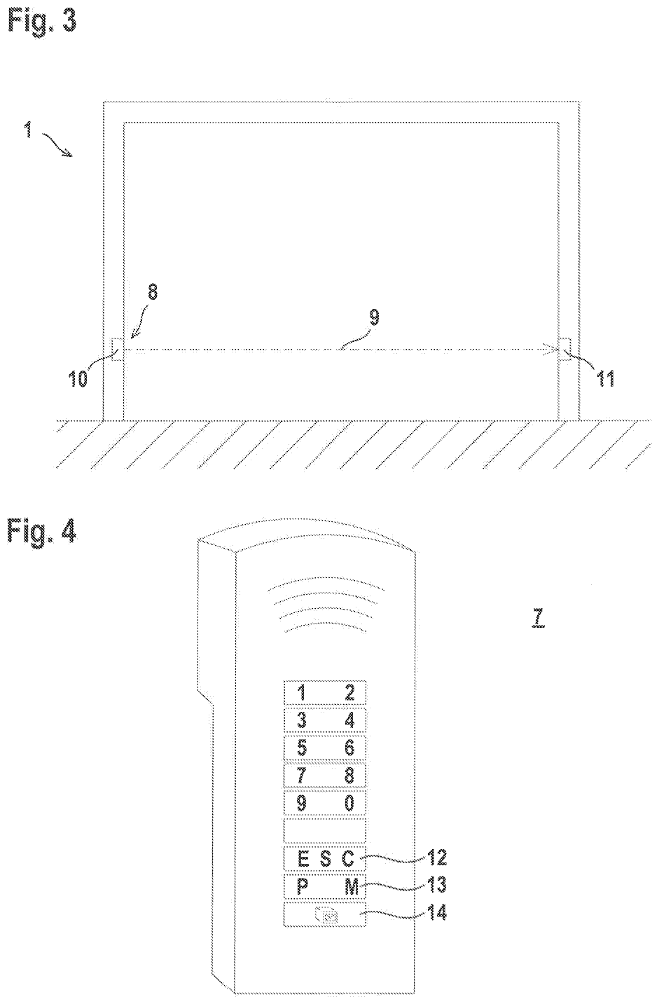

FIG. 3 shows an expansion of the drive system from FIG. 1. A safety means is provided there in the form of a light barrier 8. The light-beam 9 emitting transmitter 10 and the light-beam 9 receiving receiver 11 are arranged on opposing edges that border the door opening. The height at which the light-barrier is arranged is less than 30 cm above the ground delimiting the bottom of the door opening. With the light-barrier 8, the safety standard requirements are satisfied for the case that the operating unit 7 is arranged such that a user cannot see into the garage door 2 while operating the operating unit 7. In this case, a movement of the garage door 2 is stopped for safety reasons once an object is detected by the light-barrier 8. Alternatively, a reflection light barrier can also be provided.

FIG. 4 shows an exemplary embodiment of the operating unit 7. The components of the operating unit 7 are integrated into a housing that is fastened in a holder (not shown) outside the garage 1.

The operating unit 7 has number keys 0-9 as well as control keys 12, 13. Furthermore, a so-called parcel key 14 is provided, which is advantageously colored for emphasis.

The operating unit 7 can be used in a certain way to initiate the opening and closing of the garage door 2 by corresponding input commands, which are forwarded wirelessly to the control unit.

According to the invention, as shown in FIG. 2, a partial opening of the garage door 2 is effected via delivery input commands input into the operating unit 7. With the partial opening, the garage door 2 is only opened partially, such that a deliverer can push an item being delivered, especially a parcel, into the garage 1 through the exposed partial opening. After a preset time, the garage door 2 then closes again automatically, such that the item stored in the garage 1 is protected against unauthorized access. The entire process is controlled solely by the operating unit 7.

A means for activating the delivery input command is confidentially communicated to the delivery person, preferably on the order with which the item is preferably ordered online, such that only the delivery person, but not an unauthorized third party, can input the delivery input command into the operating unit 7.

In the present case, the parcel key 14 is used as the means, which is communicated to the delivery person on the order.

In this variant, there is the risk of an unauthorized third party pressing the parcel key 14 and thereby generating the delivery input command.

Alternatively, and especially in the case that the operating unit 7 does not have a parcel key 14, a code is entered as a means for activating the delivery input command using the number keys, which code is confidentially communicated to the delivery person. This represents a tamper-proof means for activating the delivery input command.

It is advantageous for the user to be able to change the code as needed in order to further augment access security.

Furthermore, various codes can be provided for activating different partial opening positions of the garage door 2.

It is advantageous for access security to be further augmented by having the light-barrier 8 integrated into the partial opening procedure. It is advantageous for the partial opening to be immediately ended before expiry of the preset time when an intervening object is detected by the light-barrier 8.

It is advantageous for access security to be even further augmented by providing a video monitoring unit for the region of the garage door 2, which unit is activated during the time of opening.

### LIST OF REFERENCE NUMERALS

(1) garage
(2) garage door
(2a) section
(3) electric drive
(4) control unit
(5) trolley
(6) guide rail
(7) operating unit
(8) light barrier
(9) light beam
(10) transmitter
(11) receiver
(12) control key
(13) control key
(14) parcel key

1. A drive system for a garage door (2) with an electric drive controlled by a control unit (4), by means of which the garage door (2) is displaceable between a closed position and an open position, and with an operating unit (7), into which input command for controlling the garage door (2) can be input, characterized in that an input command designed as a delivery input command is provided, that in the event of a delivery input code being entered, the operating unit causes a partial opening of the garage door (2) for a preset time, wherein after expiry of this time, the operating unit (7) causes the garage door (2) to move into the closed position.

2. The drive system according to claim 1, characterized in that the operating unit (7) has means for activating the delivery input command, which means are known to a delivery person delivering the item.

3. The drive system according to claim 2, characterized in that an operating element is provided as means for activating the delivery input command on the operating unit (7).

4. The drive system according to claim 3, characterized in that the operating element is formed by a separate key.

5. The drive system according to claim 2, characterized in that a code can be entered into the operating unit (7) as means for activating the delivery input command.

6. The drive system according to claim 5, characterized in that the code is input by entering a sequence of keys on the operating unit (7).

7. The drive system according to claim 5, characterized in that multiple codes can be input in order to trigger different delivery input commands.

8. The drive system according to claim 7, characterized in that different partial opening positions of the garage door (2) are effected by entering different codes.

9. The drive system according to claim 1, characterized in that the means for activating the delivery input command are communicated to the delivery person along with the order for the item being delivered.

10. The drive system according to claim 1, characterized in that the operating unit (7) forms a unit permanently installed in place.

11. The drive system according to claim 1, characterized in that the garage door (2) is capable of closing a door opening of a garage (1), wherein the operating unit (7) is arranged outside the garage (1).

12. The drive system according to claim 1, characterized in that a wireless connection is provided for a data exchange between the operating unit (7) and the control unit (4).

13. The drive system according to claim 1, characterized in that a light-barrier arrangement is provided as security means, wherein after an activation and subsequent clearing of the light-barrier arrangement during the time of the partial opening, the garage door (2) is closed immediately, and/or a video monitoring unit for the region of the garage door (2) is provided.

14. The drive system according to claim 1, characterized in that the operating unit (7) sends commands to a control unit (4) controlling the electric drive.

15. The drive system according to claim 14, characterized in that the control unit (4) sends an acknowledgment command back in response to a command from the operating unit (7), wherein if after a command from the operating unit (7) to close the garage door (2) the operating unit (7) does not receive an acknowledgment command from the control unit (4) to the effect that the garage door has been closed, the operating unit (7) sends the command to close the garage door (2) once again to the control unit (4).
